(19) United States
(12) Patent Application Publication
(10) Pub. No.: US 2026/0367399 A1
(43) Pub. Date: Nov. 19, 2026

(54) SYSTEM FOR AUGMENTED REALITY BEAUTY GLASSES

(71) Applicant: L'Oréal, Paris (FR)

(72) Inventor: Grégoire CHARRAUD, Jersey City, NJ (US)

(73) Assignee: L'Oréal, Paris (FR)

(21) Appl. No.: 19/724,492

(22) Filed: Jun. 29, 2026

(51) Int. Cl. G02B 27/01; G06F 3/01; G09B 5/06; G09B 5/14

(52) U.S. Cl. CPC G02B 27/017; G06F 3/011; G09B 5/06; G09B 5/14; G02B 2027/0138; G02B 2027/014; G02B 2027/0178

(57) ABSTRACT

A system for providing a beauty recommendation, the system including at least one augmented reality (AR) beauty device, including one or more sensors configured to map a physical environment, one or more cameras configured to capture images of a user's point of view, a wireless communication module, and a glasses frame having two lenses, wherein the two lenses each configured to project AR images directly onto a retina of a user, wherein the AR beauty device is configured for activating when the user looks at a reflection of the user or a second person, and a projector configured for emitting one or more visual fiducials onto the user or the second person.

### SUMMARY

In one aspect, disclosed herein is a system for providing a beauty recommendation, the system including at least one augmented reality (AR) beauty device, including one or more sensors configured to map a physical environment, one or more cameras configured to capture images of a user's point of view, a wireless communication module, and a glasses frame having two lenses, wherein the two lenses each configured to project AR images directly onto a retina of a user, wherein the AR beauty device is configured for activating when the user looks at a reflection of the user or a second person, and a projector configured for emitting one or more visual fiducials onto the user or the second person.

In some embodiments, the one or more visual fiducials map a face of the user or the second person.

In some embodiments, the projector is further configured for receiving an overlay of a makeup style, and projecting the overlay onto the user or the second person.

In some embodiments, the at least one AR beauty device is a plurality of AR beauty devices. In some embodiments, the wireless communication module of each AR beauty device of the plurality of AR beauty devices is configured to communicatively couple the plurality of AR beauty devices to a smart device. In some embodiments, the wireless communication module of each AR beauty device of the plurality of AR beauty devices is configured to communicatively couple the plurality of AR beauty devices to each other.

In some embodiments, at least one AR beauty device of the plurality of AR beauty devices is designated as a teacher AR beauty device, and all other AR beauty devices of the plurality of AR beauty devices are designated as student AR beauty devices. In some embodiments, the teacher AR beauty device is configured for capturing images of a teacher user of the teacher AR beauty device as the teacher user applies makeup, and transmitting the makeup applied by the teacher user as an overlay to the student AR beauty devices. In some embodiments, the student AR beauty devices are configured for receiving the overlay from the teacher AR beauty device, and projecting the overlay onto a student user.

In some embodiments, the overlay is a real-time image of the makeup applied by the teacher user.

In some embodiments, the student beauty devices are further configured for providing real time feedback to the student user.

In another aspect, disclosed herein is a method of applying makeup with a plurality of AR beauty devices, each AR beauty device of the plurality of AR beauty devices comprising, one or more sensors configured to map a physical environment, one or more cameras configured to capture images of a user's point of view, a wireless communication module, and a glasses frame having two lenses, wherein the two lenses each configured to project AR images directly onto a retina of a user, the method including designating the at least one AR beauty device as a teacher AR beauty device, designating the all other AR beauty devices as student AR beauty devices, capturing a makeup application of a teacher user with the teacher AR beauty device, converting the makeup application into an overlay, and transmitting the overlay onto each student user of a plurality of student users with the AR student beauty devices.

In some embodiments, the overlay is a real-time overlay that tracks a real-time makeup application of the teacher user. In some embodiments, the overlay provides a guide to the student users to apply identical makeup as the makeup application of the teacher user. In some embodiments, the method further includes when the student users deviate from the overlay, providing feedback to the student users. In some embodiments, the feedback is a tone, a vibration, or visual feedback. In some embodiments, the method further includes when the student users match the overlay, providing feedback to the student users. In some embodiments, the feedback is a tone, a vibration, or visual feedback.

In some embodiments, the method further includes communicatively coupling the plurality of AR beauty devices to each other and to at least one smart device, wherein the smart device is configured for adjusting the overlay, providing one or more recommendations, accounting for an external factor of a student user of the student users, including a skin tone, an eye color, a hair color, a temperature, a humidity, an allergy, or a combination thereof, or a combination thereof.

In some embodiments, the student AR beauty devices are further configured for determining at least one external factor of a single student user of the student users, including a skin tone, an eye color, a hair color, a temperature, a humidity, an allergy, or a combination thereof, and adjusting the overlay based on the at least one external factor.

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIGS. 1A-1B is an example augmented reality (AR) beauty device, in accordance with the present technology;

FIGS. 2A-2C are examples of an AR beauty device in use, in accordance with the present technology;

FIG. 3 is an example system including an AR beauty device and a smart device, in accordance with the present technology;

FIG. 4A is another example system including a plurality of AR beauty devices and a smart device, in accordance with the present technology;

FIG. 4B is an example of the system of FIG. 4A in use, in accordance with the present technology; and

FIG. 5 is an example method of using the system of FIG. 4A, in accordance with the present technology.

### DETAILED DESCRIPTION

Disclosed herein are devices, systems, and methods of using augmented reality (AR) beauty devices. In some embodiments, the systems disclosed herein are used to assist a user in applying makeup, diagnosing skin conditions, getting product recommendations, and trying new styles. In other embodiments, the systems disclosed herein may be used for teaching a person to apply makeup, either through video or in-person classes. In some embodiments, the AR beauty devices disclosed herein are configured for displaying an overlay of makeup on a user's face to assist them with applying makeup. The AR beauty devices may also project a number of fiducials onto the user's face to assist with makeup application or skin condition diagnosis.

The devices and systems disclosed herein may also be used to provide personalized recommendations and product recommendations to the user, store and track a user's skin condition over time, or adjust makeup overlays in response to user preference and user factors (such as skin tone, hair color, eye color, skin type, skin texture, and the like).

The devices disclosed herein may include multiple hardware modules, including but not limited to a 12 MP ultra-wide camera functioning as a main sensor, capturing high-resolution images (such as 4032×3024) and video (such as 1440×1920) for analysis. In some embodiments, included is a 600×600 p, 90 Hz full-color HUD that serves as an output, projecting private, non-intrusive AR overlays, notifications, and step-by-step guides into the user's right eye. The full color HUD may have a brightness of up to 5000 nits ensures visibility in various lighting conditions. In some embodiments, the device further includes a 6-microphone array with beamforming technology ensures accurate capture of voice commands even in noisy environments. Open-ear speakers provide audio guidance without obstructing ambient sound, critical for in-store professionals. Further, onboard storage caches frequently used tutorials or user data for offline access. The device may utilize Bluetooth and Wi-Fi connectivity ensure a stable link to the companion app and the cloud.

Further, the devices and systems disclosed herein may leverage software to operate, including an AI Engine, which hosts a suite of machine learning models, and one or more computer vision algorithms for facial landmark detection, skin texture analysis (detecting wrinkles, pores, pigmentation), colorimetric analysis for foundation/lipstick shade matching, and pattern recognition for identifying specific beauty devices for tutorials. The device may further include Natural Language Processing (NLP) To interpret user voice commands and queries, and a recommendation engine to cross-references analysis results with a product database, user history, and environmental data (UV, pollution) to generate personalized recommendations.

In some embodiments, the device includes data storage configured for securely storing user data, including images, analysis results, and preferences, allowing for model training and improved personalization over time. An API gateway may be included to manage communication between the companion app, the AI engine, and third-party services (e.g., e-commerce platforms, personalization machines, teledermatology).

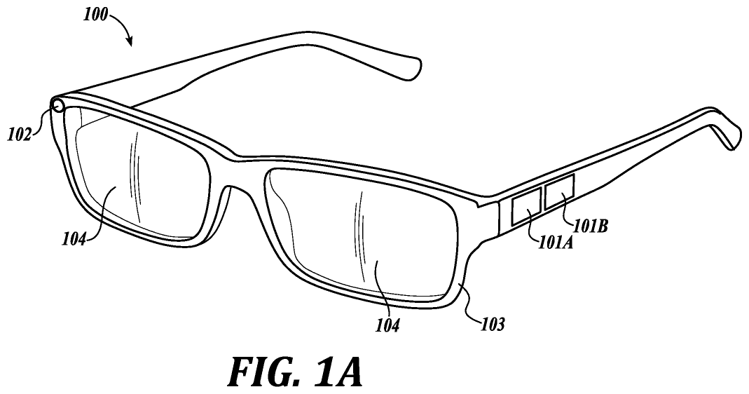

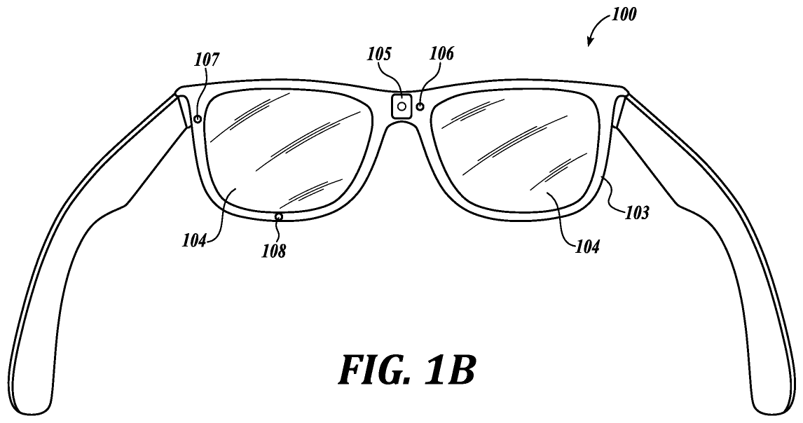

FIGS. 1A-1B show an example augmented reality (AR) beauty device 100, in accordance with the present technology. In some embodiments, the AR beauty device 100 includes one or more sensors 101A, 101B. The one or more sensors 101A, 101B may be located on an arm of the AR beauty device 100 (as shown in FIG. 1A). In other embodiments, the one or more sensors 101A, 101B may be located on the front of the AR beauty device 100 (such as near camera 102) or inside the frame of the AR beauty device (as shown in FIG. 1B).

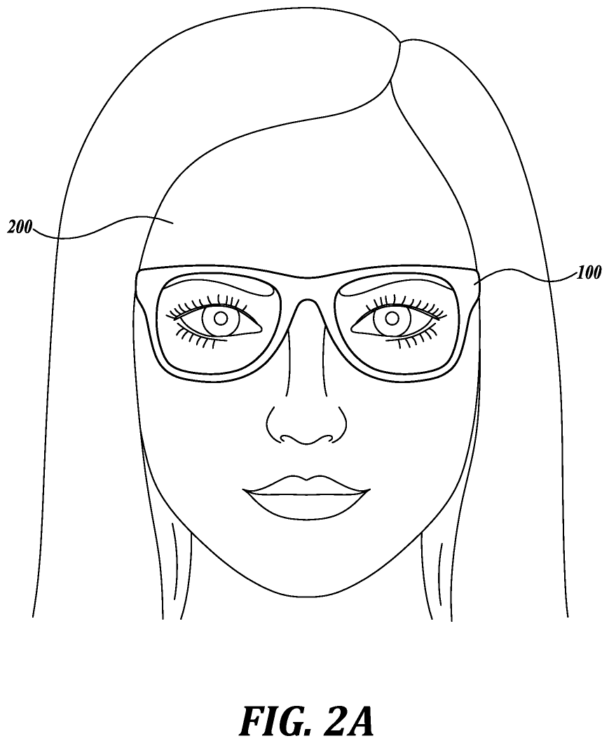

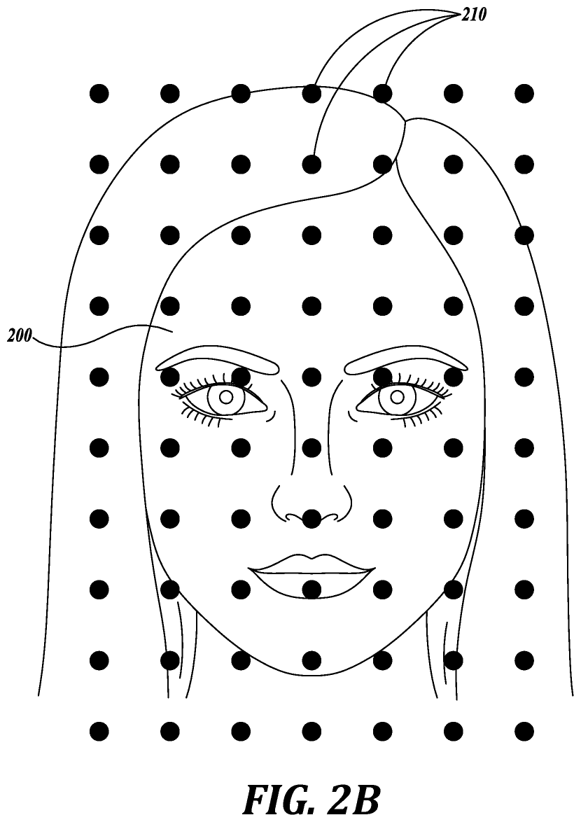

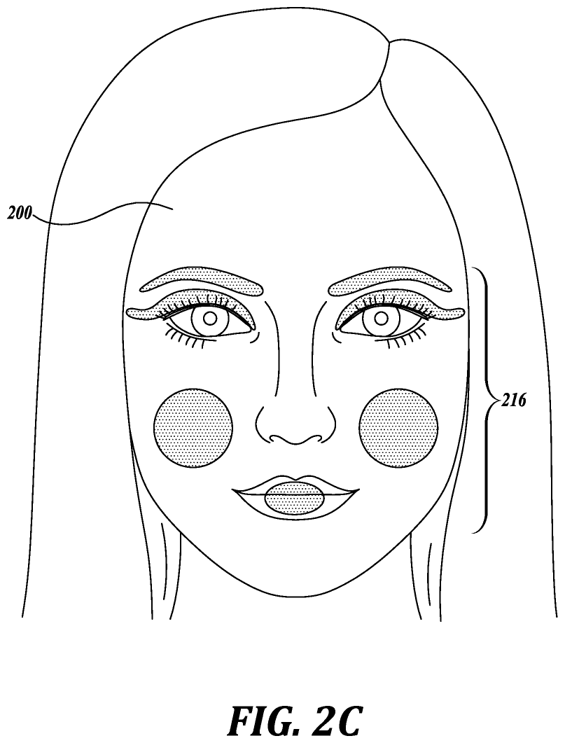

The AR beauty device 100 may further include a camera 102. The camera 102 may be configured for capturing images (such as photos or videos) of a user's point of view. That is, when the user is wearing the AR beauty device 100 (such as shown in FIG. 2A), the camera may capture images of what the user is looking at. While a single camera 102 is illustrated, it should be understood that any number of cameras may be included in the AR beauty device 100.

The AR beauty device 100 also includes a glasses frame 103, and two lenses 104. The lenses 104 are configured to project AR images directly onto the retina of the user.

In operation, when a user wears the AR beauty device 100, the camera may capture images in front of the user, while the one or more sensors 101A, 101B collect data. In some embodiments, the one or more sensors 101A, 101B may be a global positioning system (GPS) for determining a user's location and/or weather, a temperature sensor configured for detecting an ambient temperature, an accelerometer to determine a location of the user, or a combination thereof. Any number of sensors 101A, 101B may be incorporated into the AR beauty device 100. When a user looks at another person (also referred to as a second person) or looks in the mirror, the AR beauty device 100 may activate. The AR beauty device 100 may then display one or more makeup styles (also referred to herein as “overlays”) onto the user. Example overlays are shown in FIGS. 2B-2C.

FIG. 1B is a backside view of an example AR beauty device 100. In some embodiments, the backside of the AR beauty device 100 may include a projector 105, a second camera 106, a speaker 107, and/or a microphone 108. In some embodiments, the second camera 106 may be an infrared camera. Optionally, a projector may be located on a backside of the AR beauty device 100 and configured to emit fiducials on the user's face. These fiducials may be physical, that is, not augmented reality.

When the camera 106 (or camera 102) is an infrared camera, the AR beauty device 100 may analyze skin conditions of the user. For example, one or more images of the user may be taken with the IR camera, one or more skin features may be detected in the one or more images, and a skin condition may be determined based on the one or more skin features.

The speaker 107 may emit multiple sounds, including commands (e.g., “apply eyeshadow here”), instructions (e.g., “primer should be applied before foundation”), one or more product recommendations (e.g., “based on your skin tone, you should purchase this shade of foundation”), or a combination thereof. These sounds may be emitted alone or in combination with the overlays and/or fiducials. For example, when the speaker 107 emits commands, the location of where a user should apply makeup could be illustrated with an overlay. In some embodiments, the speaker 107 is configured to emit an auditory alert, such as a chime or tone, to assist in applying makeup. For example, if a user tries to apply eyeshadow to their cheek, the speaker 107 may emit a tone to alert the user to the improper application. Alerts can take many forms, including auditory, visual, or haptic. In some embodiments, the AR beauty device 100 may be configured to vibrate or pulse, emit light, or display an AR visual as an alert.

The microphone 108 may receive a number of voice commands from the user. For example, the user may request any of the sounds explained above, such as a request for a color analysis, a skin analysis, a makeup analysis, instructions, product analysis, product recommendations, and combinations thereof.

The AR beauty device 100 may then execute the voice command with a sound, overlay, AR image, or a combination thereof. The AR beauty device 100 may recommend products in response to a voice command (“find me a lipstick in this color”) or an activity by the user (such as applying makeup (“you might like this new blush”), going into sunlight (“you should consider purchasing this sunscreen”), or getting their hair dyed (“now that you have colored hair, you should consider a color protecting shampoo”)).

FIGS. 2A-2C are examples of an AR beauty device in use, in accordance with the present technology. FIG. 2A shows a user 200 using the AR beauty device 100. The AR beauty device 100 is configured to be worn as a pair of glasses would be.

In FIG. 2B, a projector (such as projector 105) emits a plurality of visual fiducials 210 on the user's face. The fiducials may take any form, including a grid as shown in FIG. 2B. The fiducials may be applied to a second person (as shown in FIG. 2B) or on the wearer (user 200) of the AR beauty device 100.

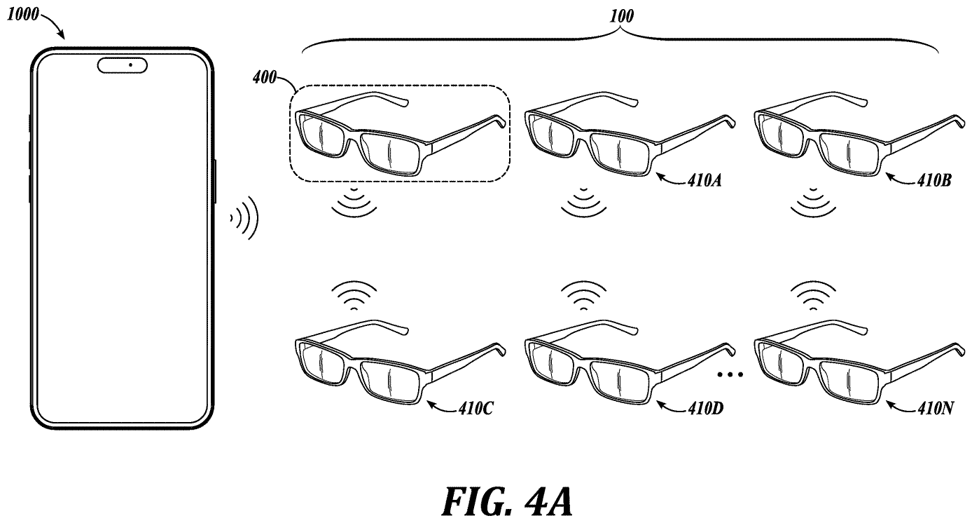

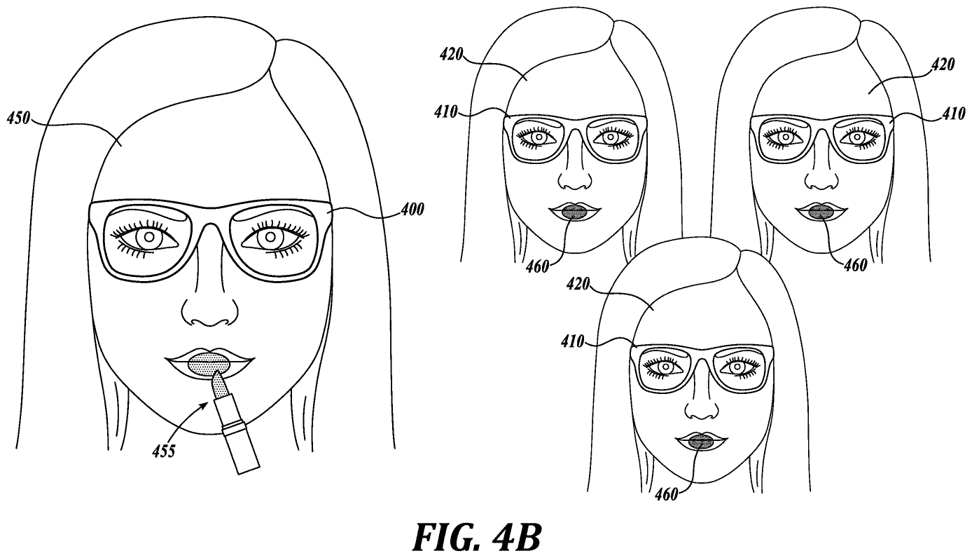

FIG. 2C shows a makeup overlay 216, which may be AR images (photos and/or videos). The makeup overlay 216 may be applied to a user 200 or a second person the user 200 is looking at. The makeup overlay 216 may be a guide or instructions for applying makeup. In other embodiments, the makeup overlay may function as makeup when the user 200 is visualized by another person also wearing the AR beauty device 100. In such embodiments, two or more AR beauty devices 100 may be communicatively coupled (as shown in FIG. 4A). When one user of the AR beauty device looks at a second user of an AR beauty device, they see the makeup overlay selected by the second user.

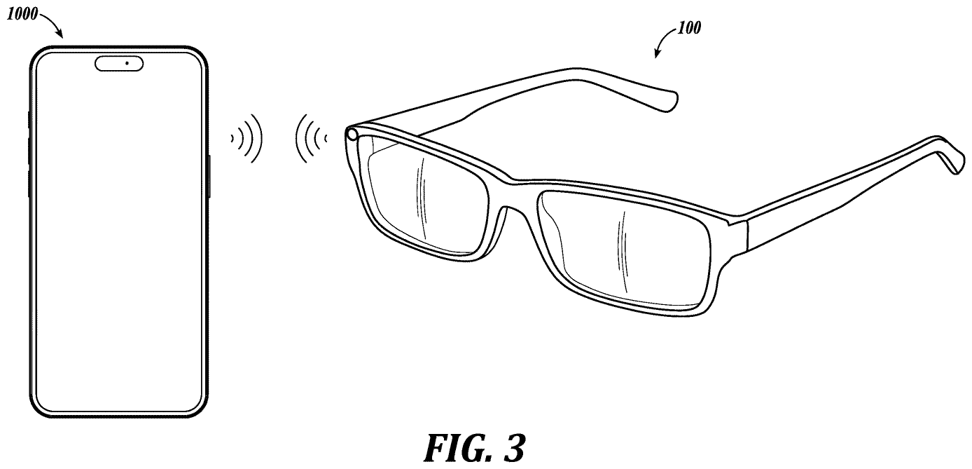

FIG. 3 is an example system including an AR beauty device 100 and a smart device 1000, in accordance with the present technology. In such systems, the smart device 1000 may be communicatively coupled to the AR beauty device 100. Example communication methods include wireless connections (Bluetooth, Bluetooth low energy, etc.), connections over Wi-Fi, Zigbee, or the like, or a wired connection.

In some embodiments, the smart device 1000 may be configured for receiving one or more product recommendations from the AR beauty device and displaying the one or more product recommendations. In some embodiments, the smart device 1000 may provide a marketplace for the user having a number of product recommendations tailored for that user. The smart device may also receive one or more user commands and transmit the one or more user commands to the AR beauty device. User commands may be given to the smart device with a user's voice or user inputs on a touch screen or keyboard of the smart device 1000.

In some embodiments, the smart device 1000 is further configured for providing feedback to the user as the user applies makeup, as explained herein. Further, the smart device 1000 may further be configured for determining a humidity, a temperature, a region, or a combination thereof, and providing a product recommendation based on the humidity, temperature, region, or a combination thereof and the images of the user's point of view. The smart device may also determine at least one external factor of the user including a skin tone, an eye color, a hair color, a temperature, a humidity, an allergy, or a combination thereof, and adjusting the overlay based on the at least one external factor.

FIG. 4A is another example system including a plurality of AR beauty devices 100 and a smart device 1000, in accordance with the present technology. In some embodiments, the AR beauty device is a plurality of AR beauty devices 100. In such embodiments, the plurality of AR beauty devices may be communicatively coupled to one another. Optionally the plurality of AR beauty devices may also be communicatively coupled to one or more smart devices 1000. For simplicity, a single smart device 1000 is illustrated, but it should be understood that any number of smart devices may be used, including a smart device for every AR beauty device of the plurality of AR beauty devices.

In some embodiments, at least one AR beauty device 400 of the plurality of AR beauty devices 100 is designated as a teacher AR beauty device 400, and all other AR beauty devices 410A, 410B, 410C, 410D . . . 410E of the plurality of AR beauty devices 100 are designated as student AR beauty devices 410A, 410B, 410C, 410D . . . 410E.

FIG. 4B is an example of the system of FIG. 4A in use, in accordance with the present technology. The teacher AR beauty device 400 may be configured for capturing images of a teacher user 450 of the teacher AR beauty device as the teacher user 450 applies makeup (makeup application 455). The teacher AR beauty device 400 may then transmit the makeup applied 455 by the teacher user 450 as an overlay 460 to the student AR beauty devices 410. Further, the student AR beauty devices 410 receive the overlay 460 from the teacher AR beauty device 400, and project the overlay 460 onto a student user 420.

It should be understood that the overlay may be an AR image. In some embodiments, the overlay is a real-time image (such as a photo or video) of the makeup application 455 of the teacher user 450.

The student beauty devices 410 may provide real time feedback to the student user through any of the mechanisms described herein. This includes auditory alerts, commands, instructions, visual alerts, haptic feedback, and combinations thereof.

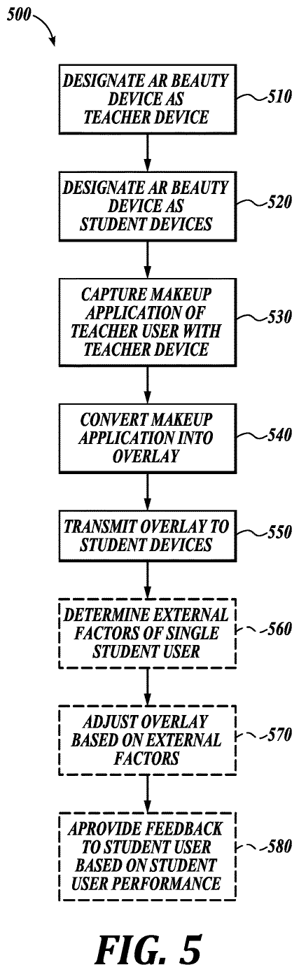

FIG. 5 is an example method 500 of using the system of FIG. 4A, in accordance with the present technology. The method 500 begins in block 510.

In block 510, at least one AR beauty device (such as AR beauty device 100) is designated as a teacher device (such as teacher device 400).

In block 520, all other AR beauty devices are designated as student AR beauty devices (such as student AR beauty devices 410 or student AR beauty devices 410A, 410B, 410C, 410D . . . 410N). The student AR beauty devices may all be located in a same location, such as classroom, or online, such as in a web-based class.

In block 530, the makeup application (such as makeup application 455) is captured with the teacher device. In some embodiments, there may not be a teacher AR beauty device, and the student AR beauty device instead extrapolates overlays based on what a user is viewing, such as a pre-recorded video of someone applying their makeup.

In block 540, the makeup application is converted into a makeup overlay (such as makeup overlay or overlay 460, 212).

In block 550, the overlay is transmitted to the student devices. In some embodiments, the overlay may include one or more product recommendations or product identifications (e.g., the teacher used a specific lipstick, so that lipstick is visualized or recommended).

Optionally, the method may include multiple steps that allow a student user. to tweak the makeup overlay for personal style, personal features, or makeup available to the student user.

In block 560, one or more external factors may be determined on a student user by student user basis. External factors include, but are not limited to, a skin tone, an eye color, a hair color, a temperature, a humidity, an allergy, a makeup inventory, or a combination thereof. In some embodiments, the one or more external factors are user inputs. For example, a user may adjust an eyeline shape due to personal preference with a smart phone or with voice commands to the AR beauty device.

In block 580, feedback is provided to the student user based on the individual student user's performance. For example, the system may encourage the student when the student properly applies the makeup and provide guidance or correction when the student makes a mistake. In some embodiments, the student AR beauty device may, when the student user deviates from the overlay, provide feedback to the student user. Further, the student AR beauty device may also may provide different feedback when the student user matches the overlay.

It should be understood that method 500 should be interpreted as merely representative. In some embodiments, process blocks of method 500 may be performed simultaneously, sequentially, in a different order, or even omitted, without departing from the scope of this disclosure.

The present application may reference quantities and numbers. Unless specifically stated, such quantities and numbers are not to be considered restrictive, but representative of the possible quantities or numbers associated with the present application. Also, in this regard, the present application may use the term “plurality” to reference a quantity or number. In this regard, the term “plurality” is meant to be any number that is more than one, for example, two, three, four, five, etc. The terms “about,” “approximately,” “near,” etc., mean plus or minus 5% of the stated value. For the purposes of the present disclosure, the phrase “at least one of A, B, and C,” for example, means (A), (B), (C), (A and B), (A and C), (B and C), or (A, B, and C), including all further possible permutations when greater than three elements are listed.

Embodiments disclosed herein may utilize circuitry in order to implement technologies and methodologies described herein, operatively connect two or more components, generate information, determine operation conditions, control an appliance, device, or method, and/or the like. Circuitry of any type can be used. In an embodiment, circuitry includes, among other things, one or more computing devices such as a processor (e.g., a microprocessor), a central processing unit (CPU), a digital signal processor (DSP), an application-specific integrated circuit (ASIC), a field-programmable gate array (FPGA), or the like, or any combinations thereof, and can include discrete digital or analog circuit elements or electronics, or combinations thereof.

An embodiment includes one or more data stores that, for example, store instructions or data. Non-limiting examples of one or more data stores include volatile memory (e.g., Random Access memory (RAM), Dynamic Random Access memory (DRAM), or the like), non-volatile memory (e.g., Read-Only memory (ROM), Electrically Erasable Programmable Read-Only memory (EEPROM), Compact Disc Read-Only memory (CD-ROM), or the like), persistent memory, or the like. Further non-limiting examples of one or more data stores include Erasable Programmable Read-Only memory (EPROM), flash memory, or the like. The one or more data stores can be connected to, for example, one or more computing devices by one or more instructions, data, or power buses.

In an embodiment, circuitry includes a computer-readable media drive or memory slot configured to accept signal-bearing medium (e.g., computer-readable memory media, computer-readable recording media, or the like). In an embodiment, a program for causing a system to execute any of the disclosed methods can be stored on, for example, a computer-readable recording medium (CRMM), a signal-bearing medium, or the like. Non-limiting examples of signal-bearing media include a recordable type medium such as any form of flash memory, magnetic tape, floppy disk, a hard disk drive, a Compact Disc (CD), a Digital Video Disk (DVD), Blu-Ray Disc, a digital tape, a computer memory, or the like, as well as transmission type medium such as a digital and/or an analog communication medium (e.g., a fiber optic cable, a waveguide, a wired communications link, a wireless communication link (e.g., transmitter, receiver, transceiver, transmission logic, reception logic, etc.). Further non-limiting examples of signal-bearing media include, but are not limited to, DVD-ROM, DVD-RAM, DVD+RW, DVD-RW, DVD-R, DVD+R, CD-ROM, Super Audio CD, CD-R, CD+R, CD+RW, CD-RW, Video Compact Discs, Super Video Discs, flash memory, magnetic tape, magneto-optic disk, MINIDISC, non-volatile memory card, EEPROM, optical disk, optical storage, RAM, ROM, system memory, web server, or the like.

The detailed description set forth above in connection with the appended drawings, where like numerals reference like elements, are intended as a description of various embodiments of the present disclosure and are not intended to represent the only embodiments. Each embodiment described in this disclosure is provided merely as an example or illustration and should not be construed as preferred or advantageous over other embodiments. The illustrative examples provided herein are not intended to be exhaustive or to limit the disclosure to the precise forms disclosed. Similarly, any steps described herein may be interchangeable with other steps, or combinations of steps, in order to achieve the same or substantially similar result. Generally, the embodiments disclosed herein are non-limiting, and the inventors contemplate that other embodiments within the scope of this disclosure may include structures and functionalities from more than one specific embodiment shown in the figures and described in the specification.

In the foregoing description, specific details are set forth to provide a thorough understanding of exemplary embodiments of the present disclosure. It will be apparent to one skilled in the art, however, that the embodiments disclosed herein may be practiced without embodying all the specific details. In some instances, well-known process steps have not been described in detail in order not to unnecessarily obscure various aspects of the present disclosure. Further, it will be appreciated that embodiments of the present disclosure may employ any combination of features described herein.

The present application may include references to directions, such as “vertical,” “horizontal,” “front,” “rear,” “left,” “right,” “top,” and “bottom,” etc. These references, and other similar references in the present application, are intended to assist in helping describe and understand the particular embodiment (such as when the embodiment is positioned for use) and are not intended to limit the present disclosure to these directions or locations.

The present application may also reference quantities and numbers. Unless specifically stated, such quantities and numbers are not to be considered restrictive, but exemplary of the possible quantities or numbers associated with the present application. Also, in this regard, the present application may use the term “plurality” to reference a quantity or number. In this regard, the term “plurality” is meant to be any number that is more than one, for example, two, three, four, five, etc. The term “about,” “approximately,” etc., means plus or minus 5% of the stated value. The term “based upon” means “based at least partially upon.”

The principles, representative embodiments, and modes of operation of the present disclosure have been described in the foregoing description. However, aspects of the present disclosure, which are intended to be protected, are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure as claimed.

While illustrative embodiments have been illustrated and described, it will be appreciated that various changes can be made therein without departing from the spirit and scope of the invention.

What is claimed is:

1. A system for providing a beauty recommendation, the system comprising:
at least one augmented reality (AR) beauty device, comprising:
one or more sensors configured to map a physical environment;
one or more cameras configured to capture images of a user's point of view;
a wireless communication module; and
a glasses frame having two lenses, wherein the two lenses each configured to project AR images directly onto a retina of a user, wherein the AR beauty device is configured for:
activating when the user looks at a reflection of the user or a second person, and
a projector configured for emitting one or more visual fiducials onto the user or the second person.

2. The system of claim 1, wherein the one or more visual fiducials map a face of the user or the second person.

3. The system of claim 1, wherein the projector is further configured for:
receiving an overlay of a makeup style; and
projecting the overlay onto the user or the second person.

4. The system of claim 1, wherein the at least one AR beauty device is a plurality of AR beauty devices.

5. The system of claim 4, wherein the wireless communication module of each AR beauty device of the plurality of AR beauty devices is configured to communicatively couple the plurality of AR beauty devices to a smart device.

6. The system of claim 5, wherein the wireless communication module of each AR beauty device of the plurality of AR beauty devices is configured to communicatively couple the plurality of AR beauty devices to each other.

7. The system of claim 6, wherein at least one AR beauty device of the plurality of AR beauty devices is designated as a teacher AR beauty device, and all other AR beauty devices of the plurality of AR beauty devices are designated as student AR beauty devices.

8. The system of claim 7, wherein the teacher AR beauty device is configured for:
capturing images of a teacher user of the teacher AR beauty device as the teacher user applies makeup; and
transmitting the makeup applied by the teacher user as an overlay to the student AR beauty devices.

9. The system of claim 8, wherein the student AR beauty devices are configured for:
receiving the overlay from the teacher AR beauty device; and
projecting the overlay onto a student user.

10. The system of claim 8, wherein the overlay is a real-time image of the makeup applied by the teacher user.

11. The system of claim 9, wherein the student beauty devices are further configured for providing real time feedback to the student user.

12. A method of applying makeup with a plurality of AR beauty devices, each AR beauty device of the plurality of AR beauty devices comprising, one or more sensors configured to map a physical environment, one or more cameras configured to capture images of a user's point of view, a wireless communication module, and a glasses frame having two lenses, wherein the two lenses each configured to project AR images directly onto a retina of a user, the method comprising:
designating the at least one AR beauty device as a teacher AR beauty device;
designating the all other AR beauty devices as student AR beauty devices;
capturing a makeup application of a teacher user with the teacher AR beauty device;
converting the makeup application into an overlay; and
transmitting the overlay onto each student user of a plurality of student users with the AR student beauty devices.

13. The method of claim 12, wherein the overlay is a real-time overlay that tracks a real-time makeup application of the teacher user.

14. The method of claim 12, wherein the overlay provides a guide to the student users to apply identical makeup as the makeup application of the teacher user.

15. The method of claim 14, further comprising:
when the student users deviate from the overlay, providing feedback to the student users.

16. The method of claim 15, wherein the feedback is a tone, a vibration, or visual feedback.

17. The method of claim 14, further comprising:
when the student users match the overlay, providing feedback to the student users.

18. The method of claim 17, wherein the feedback is a tone, a vibration, or visual feedback.

19. The method of claim 12, further comprising communicatively coupling the plurality of AR beauty devices to each other and to at least one smart device, wherein the smart device is configured for:
adjusting the overlay;
providing one or more recommendations;
accounting for an external factor of a student user of the student users, including a skin tone, an eye color, a hair color, a temperature, a humidity, an allergy, or a combination thereof; or
a combination thereof.

20. The method of claim 12, wherein the student AR beauty devices are further configured for:
determining at least one external factor of a single student user of the student users, including a skin tone, an eye color, a hair color, a temperature, a humidity, an allergy, or a combination thereof; and
adjusting the overlay based on the at least one external factor.
